(19) United States
(12) Patent Application Publication
(10) Pub. No.: US 2022/0373346 A1
(43) Pub. Date: Nov. 24, 2022

(54) PERSONALIZED ROUTE RECOMMENDATION AND NAVIGATION

(71) Applicant: Meta Platforms Technologies, LLC, Menlo Park, CA (US)

(72) Inventors: Abhishek ABHISHEK, Acton, MA (US); Andrew James Forchione, Macedonia, OH (US)

(73) Assignee: Meta Platforms Technologies, LLC, Menlo Park, CA (US)

(21) Appl. No.: 17/737,747

(22) Filed: May 5, 2022

Related U.S. Application Data
(60) Provisional application No. 63/191,373, filed on May 21, 2021.
(60) Provisional application No. 63/219,692, filed on Jul. 8, 2021.
(60) Provisional application No. 63/249,446, filed on Sep. 28, 2021.

(51) Int. Cl. G01C 21/34; G01C 21/36; G06V 20/13; G06V 20/10; G06V 10/82; G06Q 20/32

(52) U.S. Cl. CPC G01C 21/3484; G01C 21/3461; G01C 21/3602; G01C 21/3647; G06V 20/13; G06V 20/188; G06V 10/82; G06Q 20/3278; G06Q 20/325; G06Q 2220/00

(57) ABSTRACT

According to examples, a system for providing personalized routes may include a processor and a memory storing instructions. The processor, when executing the instructions, may cause the system to receive a user request for a personalized route wherein the user request can include at least a route origin and destination. The processor employs the user request to identify the user and retrieves the user's preferences from different recommender systems. The recommendations output by the recommender systems are ranked based on context data associated with the user request. The geographic locations associated with a predetermined number of top-ranked recommendations are obtained and a personalized route that passes through a maximum number of the geographic locations is built for a display to the user.

### PRIORITY

This patent application claims priority to U.S. Provisional Patent Application No. 63/191,373, entitled “Personalized Route Recommendation and Navigation,” filed on May 21, 2021, U.S. Provisional Patent Application No. 63/219,692, entitled “Route Generation with Turn-by-Turn Instructions,” filed on Jul. 8, 2021, and U.S. Provisional Patent Application No. 63/249,446, entitled “Directed Transmission of Wireless Signals to Initiate, Authenticate and Facilitate Secure Transactions,” filed on Sep. 28, 2021, all of which are hereby incorporated by reference herein in their entireties.

### TECHNICAL FIELD

This patent application relates generally to mapping and navigation technologies, and more specifically to systems and methods for personalized route recommendation and navigation. This patent application relates generally to mapping and navigation technologies, and more specifically to systems and methods for simplifying and optimizing route generation and navigation including artificial intelligence (AI) based turn-by-turn instructions. This patent application relates generally to digital content, communications, and transactions, and more specifically, to systems and methods for utilizing directed transmission of wireless signals to initiate, authenticate, and facilitate a secure transaction between a first transaction device and a second transaction device.

### BACKGROUND

Mapping applications receive a user's input regarding an origin and a destination and provide a route for the user to take depending on the user's selected mode of transportation. These applications typically employ Global Positioning System (GPS) data and mobile networks to track the user en route and may provide updates as needed. Some mapping applications also provide voice-enabled turn-by-turn guidance for the users. Other functions enabled on mapping applications include providing information along a route so that the user can choose to stop at particular spots as desired. With the current advances in technology, the prevalence and proliferation of digital content creation and delivery have increased greatly in recent years. Some digital content delivery and management systems may collect and manage user preferences to enable customized digital content delivery to the users. However, conventional digital content delivery systems may not have reliable mechanisms to avoid over-targeting users. Furthermore, such systems may lack the capability to determine the effectiveness of the digital content delivered to the users in the absence of explicit user feedback. As a result, irrelevant or obsolete digital content may be delivered to users thereby causing content distribution inefficiencies and lowering quality of user experience.

Mapping applications generally provide some form of navigation directions by default. Conventional mapping applications may receive a user's input regarding an origin and a destination and provide a route for the user to take depending on the user's selected mode of transportation. Although some conventional mapping applications may also be enabled for pedestrian navigation offering users walking directions, most of these solutions do not offer accurate or reliable turn-by-turn instructions that are particularly helpful in urban environments via pedestrian-specific maps, or users on biking or hiking trails or other similar outdoor scenarios.

The proliferation of electronic commerce has enabled customers to transact with numerous merchants to secure goods and services that they seek. Typically, a customer may be required to provide various personal information to facilitate a transaction. Examples may include the customer's name, payment information, and/or authentication information.

In some instances, it may be beneficial for a customer to provide supplemental information in order to more efficiently or expediently conduct a transaction. This supplemental information may include the customer's browsing history, purchase history, and preferences (i.e., likes). However, in many instances, it may be a burdensome to transfer this supplemental information from a source device to a transacting device in order to facilitate the transaction.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a block diagram of a computer system used for personalized route recommendation, according to an example.

FIG. 1B illustrates a block diagram of a memory included in the computer system used for generating personalized route recommendations, according to an example.

FIG. 1C illustrates a flowchart for a method of building routes based on user preferences accordingly to an example.

FIG. 2 shows a block diagram of a personalized route recommendation system according to an example.

FIG. 3 shows a block diagram of the personalized route recommendation system with sample displays according to an example.

FIG. 4 includes a flowchart that illustrates a method of providing personalized route recommendations according to an example.

FIG. 5 illustrates a block diagram of a system for providing recommendations, according to an example.

FIG. 6A illustrates a block diagram of a computer system used for generating an optimized route, according to an example.

FIG. 6B illustrates a block diagram of a memory included in the computer system used for generating the optimized route according to an example.

FIG. 6C shows a flowchart for route optimization according to an example.

FIG. 7 shows an optimized route according to an example.

FIG. 8 shows another example of route optimization.

FIG. 9 illustrates a block diagram of a transaction device, according to an example.

FIG. 10A illustrates a diagram a system environment including a plurality of transaction devices in a first configuration, according to an example.

FIG. 10B illustrates a diagram a system environment including a plurality of transaction devices in a second configuration, according to an example.

FIG. 11 illustrates a block diagram of a transaction device, according to an example.

FIG. 12 illustrates a block diagram of a transaction device, according to an example.

FIG. 13 illustrates a method for utilizing directed transmission of wireless signals to initiate, authenticate and facilitate a secure transaction between a first transaction device and a second transaction device, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As described above, a navigation engine can provide routing instructions between two or more places. While conventional navigation engines take traffic data and some user preferences (such as toll, highway avoidance, scenic routes, etc.) into account or may provide information regarding retail outlets along the way, current technologies lack a more personalized route recommendation and navigation experience for users. As the next generation augmented reality (AR) devices are built, users may demand navigation experiences that are more personalized, and as such, may emerge as the key differentiating factor for devices in the augmented reality (AR), virtual reality (VR), and/or mixed reality (MR) domain.

Systems and methods for personalization of travel routes based on user preferences are disclosed. The personalized route recommendation system generates described herein may provide a personalized route that takes into consideration specific user preferences in response to a received user routing request. The user routing request may include certain requirements or request attributes such as the route origin, destination, and specific interests (libraries, gas stations, coffee shops, etc.). The personalized route recommendation system may access a plurality of data sources to retrieve user data and context data related to the user request. The context data can include data that pertains to the user request but does not encompass specific user preferences or which may be common to users at a given location. Examples of context data may include, but are not limited to, weather data, specific day (i.e., if a holiday such as independence day, etc.) time of the day, route data (i.e., location data, crime rate along the route, scenic spots along the route, tourist attractions, traffic data, etc.), or other data. The user preferences may be ranked based on the context data and the locations associated with the user preferences are retrieved. One or more routes between the origin and the destination that pass through the places of interest or locations associated with the user preferences may be built and presented to the user. If the user selects one of the routes for navigation, the directions to the destination based on the selected route may be further displayed upon receiving the user selection.

The route recommendation system according to the examples laid out herein may be “intelligent,” understanding or predicting a user's preferences (e.g., using any number of artificial intelligence (AI) or machine learning (ML) based approaches). In other words, the systems and methods described herein may not simply be based on static inputs but also uses artificial intelligence (AI) or machine learning (ML) based techniques to learn user's preferences over a period of time. In addition to the user's static and learnt preferences, the personalized route recommendation system described herein may also use or superimpose context data such as time of the day, current location, home location, etc. to create navigation experiences that are personalized for individual users, ultimately providing a customized route and navigation experience tailored to users.

As described above, a navigation engine can provide routing instructions between two or more places. Conventional navigation engines are generally geared towards driving routes with clearly defined intersections and turns. However, all routes may not have such well-defined intersections. Some routes such as those in downtowns, pedestrian routes, or hiking trials may have turns that are complicated due to sidewalks, pedestrian crossings, jug-handle turns, etc. Current technologies lack the sophistication to identify such route complexities and provide accurate instructions. As a result, the instructions output by conventional mapping or routing applications may generate inaccurate or unreliable instructions, often leading to complicate or inefficient navigation, such as redundant turns on the same street which can be confusing to users or travelers.

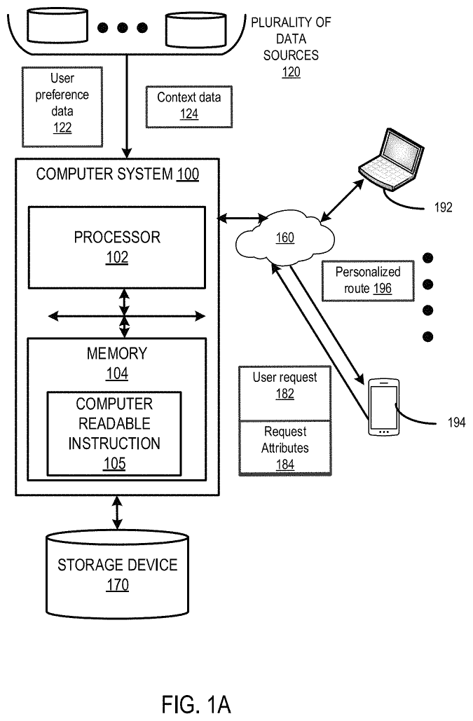

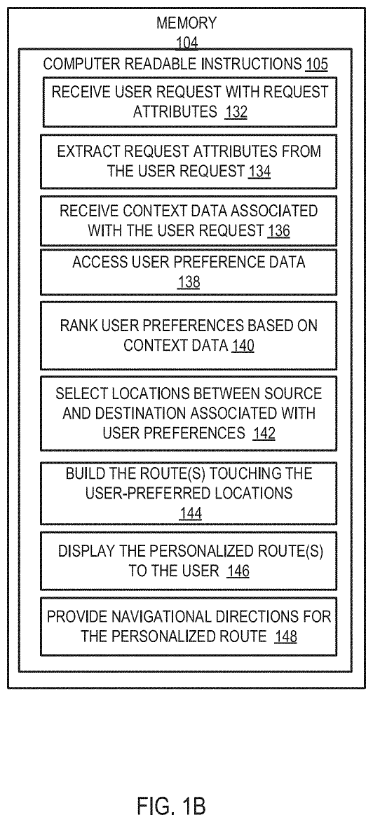

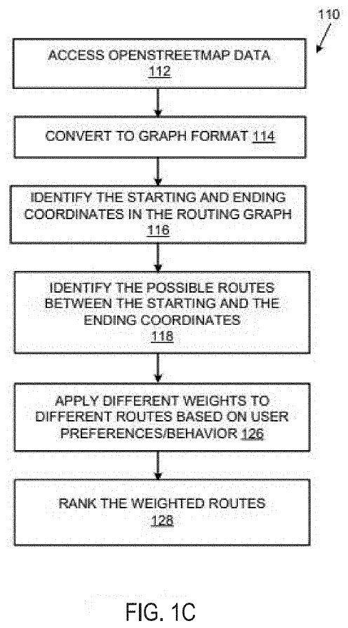

Reference is now made with respect to FIGS. 1A and 1B which illustrate a block diagram of a computer system 100 and a memory 104 included therein that is used for route personalization and recommendation, according to an example. As shown in FIG. 1A the computer system 100 may include a processor 102 and a memory 104. FIG. 1B illustrates a block diagram of the memory 104 including computer-readable instructions 105, that when executed by the processor 102 may be configured to provide personalized routes over user communications devices 192, 194 . . . , etc., according to an example. The user communication devices may be electronic or computing devices configured to transmit and/or receive data (e.g., via a social media application), and in one example, the user communication devices 192, 194 . . . , etc., may include a smartphone, a laptop, a smartwatch, an augmented Reality (AR)/virtual reality (VR) device. The computer system 100 may also be connected to a plurality of data sources 120 to access user preference data 122, context data 124, etc. The plurality of data sources 120 may include but are not limited to, places data, check-in data for a user, traffic and weather data, the user's likes of various places such as restaurants, libraries, stores, parks, hiking trails, etc., the user's home location, the user's routine commute routes, street map data with specific information regarding sidewalks, streetlights, etc.

The computer system 100 may communicate with the user communication devices 192, 194, . . . etc., via a network 160 that can be a local area network (LAN), a wide area network (WAN), the Internet, a cellular network, a cable network, a satellite network, or another network. Network 160 may further include one, or any number, of the exemplary types of networks mentioned above operating as a stand-alone network or in cooperation with each other. For example, the network 160 may utilize one or more protocols of one or more clients or servers to which they are communicatively coupled. Network 160 may facilitate the transmission of data according to a transmission protocol of any of the devices and/or systems in the network 160. Although network 160 is depicted as a single network, it should be appreciated that, in some examples, the network 160 may include a plurality of interconnected networks as well.

It should be appreciated that the systems and subsystems shown and described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the servers, systems, subsystems, and/or other computing devices may be shown as single components or elements, it should be appreciated that one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the computer system 100 or the system environment including the computer system 100, the user communication devices 192, . . . etc., and the plurality of data sources 120.

The computer system 100 may further include the storage device 170. In one example, the storage device 170 may include any number of servers, hosts, systems, and/or databases that store data to be accessed by the computer system 100 or other systems (not shown) that may be communicatively coupled thereto. Also, in one example, the servers, hosts, systems, and/or databases of the storage device 170 may include one or more storage mediums storing any data, and may be utilized to store information (e.g., user information, demographic information, preference information, etc.) relating to users of a social media application facilitating the generation and transmission of dynamic route information.

The computer system 100 can be communicatively coupled to the plurality of data sources 120 to receive the user preference data 122 and the context data 124. The user preference data 122 can include data explicitly provided by the user to the personalized route recommendation system or other platforms or implicit data gathered from user behavior on the personalized route recommendation system or platforms such as social media applications. For example, a user's likes, check-ins, the user groups joined by the user on the social media platform, posts, ratings for various products/services, home location, etc., can be used to gather user preferences for route personalization. The learned user preferences may be restricted to a finite number of categories in an example so that only restaurants, sightseeing, fitness, etc. are considered so that the route identification can be treated like a topic classification problem. The learned user preferences will be regularly updated automatically as new data becomes available.

The processor 102 in the computer system 100 accesses the computer-readable instructions 105 from the memory 104 to execute various processes that enable the personalized route generation as described herein. In one example, the memory 104 may have stored thereon machine-readable instructions (which may also be termed computer-readable instructions) that the processor 102 may execute. The memory 104 may be an electronic, magnetic, optical, or another physical storage device that contains or stores executable instructions. The memory 104 may be, for example, Random Access Memory (RAM), an Electrically Erasable Programmable Read-Only Memory (EEPROM), a storage device, an optical disc, or the like. The memory 104, which may also be referred to as a computer-readable storage medium, may be a non-transitory machine-readable storage medium, where the term “non-transitory” does not encompass transitory propagating signals.

More particularly, the processor 102 can execute instructions 132 to receive a user request 182 for a personalized route. The user request 182 can include certain request attributes 184. The request attributes 184 include at least the origin and destination for the route to be generated. The request attributes may optionally include the mode of transport that the user proposes to employ, and certain route constraints that may be placed by the user i.e., whether the user would prefer the shortest/fastest route or a scenic route, or preferred stops along the route, or specific locations to avoid, etc. If the user does not provide specific preferences then the computer system 100 may employ default preferences from the user's profile or may provide specific suggestions for such attributes. For example, if the mode of transport is not specified, then multiple personalized routes with different transportation modes are generated and displayed for user selection.

The processor 102 executes instructions 134 to extract the request attributes 184 from the user request 182. In an example, the user request 182 can be received via a user interface (UI) put forth by the personalized route recommender system so that values entered by the user in specific UI elements can be mapped to the corresponding data fields to be extracted from the user request 182.

The processor 102 executes instructions 136 to retrieve context data 124 associated with the user request. As mentioned above, the context data 124 can include data associated with the user request 182 and which may not be user-specific. Non-limiting examples for the plurality of data sources 120 may include, data sources from The Weather Company that provides weather data, OpenStreetMap which provides route data such as data regarding sidewalks, streetlights, etc., along different routes, Maxar, NCTech data sources that provide satellite imagery for identifying scenic routes, etc. In an example, a deep learning (DL) model can be trained to identify greener/scenic areas. This can be achieved by using an image classification approach. Such image data can be combined with data from other data sources such as OpenStreetMap data, to identify and tag the roads closer to the scenic areas. In an example, OpenStreetMap data may already have been tagged with many green areas so good results for scenic route identification can be obtained from OpenStreetMap data alone without the necessity to access the satellite data or the DL models.

In an example, the plurality of data sources 120 can include data streams that provide continuous updates. The context data 124 may be refreshed periodically from the context data sources. For example, weather data may be refreshed every 3 hours on normal weather days whereas traffic data may be continuously received via a traffic data stream.

The processor 102 may execute instructions 138 to access the user preference data 122. The user preference data 122 can include user preferences for food, shopping, fitness, sightseeing, etc. In an example, the user preference data 122 can be obtained from a social media platform based on the user likes, check-ins, social groups, posts, ratings, etc. In an example, the user may provide explicit information during the registration process regarding the type of data that may be considered for route personalization. The user preference data 122 may also be updated automatically as new data becomes available.

The processor 102 may execute instructions 140 to rank the user preferences from the user preference data 122 based on the context data 124. For example, if the time in the context data indicates morning time, then the user preference data 122 can rank the user's preferred coffee shops/breakfast places higher than cinemas or places of entertainment. Conversely, the user's preferred places of entertainment may be ranked above coffee shops during the evening time. For example, if the user has liked several Vietnamese restaurants and/or checked-in multiple times, any Vietnamese restaurants between the origin and destination may be ranked higher during noon or evening times. Thus, the ranking of user preferences is affected by the context data 124. If the user's request attributes indicate that the user prefers a scenic route, then information from satellite data sources can be retrieved to determine the scenic spots between the origin and the destination.

The processor 102 executes instructions 142 to select places of interest/locations between the origin and the destination associated with user preferences. The location data of top N (where N is a natural number and N=1, 2, 3 . . . ) preferences can be retrieved and selected by the processor 102. More particularly, the retrieved locations may be selected based on their positions within a predetermined radius between the origin and the destination.

The processor 102 executes instructions 144 to build route(s) between the origin and the destination that pass through the places of interest.

The processor 102 executes instructions 146 to display one or more routes built to pass through places of interest to the user on the user communication device 194.

If the user chooses to use the personalized route, then the processor executes instructions 148 to provide navigational directions for the personalized route 196. If multiple personalized routes are displayed, then the user's consent/selection of one of the personalized routes is received and the navigational instructions for the selected route are displayed along with the places of interest information. For example, the locations of the user's preferred restaurants, coffee shops, places of interest, etc., may be marked out along the personalized route 196 with their corresponding distances/time of travel from the origin.

In an example, the routes for different origin/destination combinations input by the user or personalized routes that were previously generated can be stored in a user profile on the personalized route recommender system e.g., in the storage device 170. Whenever the user preference data 122 or the context data 124 is updated, the route information may also be updated. If a specific route is frequently selected by the user, then such a frequently-selected route may be suggested by default at the outset.

FIG. 1C illustrates a flowchart 110 for a method of building route(s) between the origin and the destination that pass through the places of interest according to an example. In an example, the method can be implemented by the computer readable instructions 144 to build the routes referred to above. The method begins at 112 wherein Openstreetmap data is accessed. The Openstreetmap data may include the various nodes representing the different locations and ways/routes connecting the locations. At 114, the data from the Openstreetmap is converted into a graph format i.e., a connected routing graph. The starting and the ending coordinates or the origin and the destination of the route to be generated are identified in the routing graph at 116. The possible edges or routes between the starting and the ending coordinates are identified at 118. In an example, methodologies such as bi-directional search or A* search can be applied to find the possible routes. Bidirectional search is a graph search algorithm that finds a shortest path from an initial vertex to a goal vertex in a directed graph. It runs two simultaneous searches: one forward from the initial state, and one backward from the goal, stopping when the two meet.

It should be appreciated that A* may refer to an informed search algorithm, or a best-first search, meaning that it is formulated in terms of weighted graphs: starting from a specific starting node of a graph, it aims to find a path to the given goal node having the smallest cost (least distance travelled, shortest time, etc.). At 126 different weights are applied to different routes. For example, if greener routes are preferred then the scenic routes may be weighed higher, whereas if user behavior indicates preferences for coffee shops then routes passing by coffee shops may be weighed higher. Furthermore, multiple preferences may be applied as cumulative weights on the routes. The weighted routes may be ranked at 128. Such ranked routes may be provided for display via execution of the instructions 144 by the processor 102.

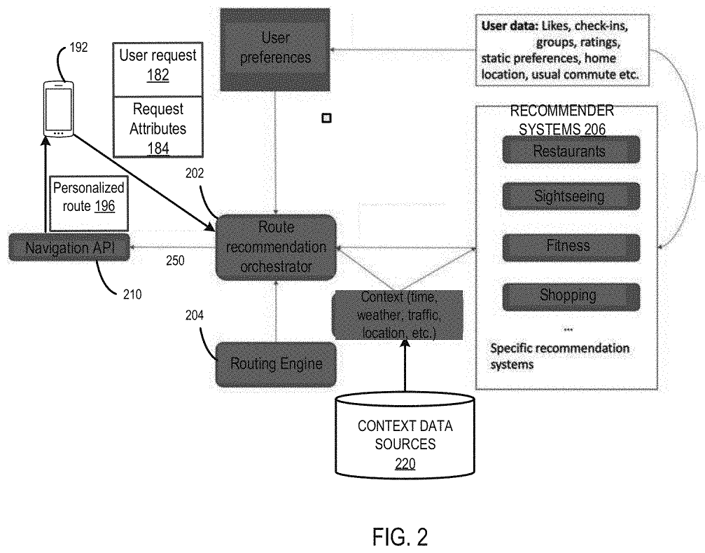

FIG. 2 shows a block diagram of the components of a personalized route recommendation system according to an example. A route recommendation orchestrator 202 receives the user request 182 for a personalized route between an origin and a destination. The user may be identified based on the ID associated with the user communication device 194 or via user login and recommendations/user preferences for the user in certain select categories important to the user can be obtained from one or more recommendation systems 206 such as but not limited to a restaurant recommender, a sightseeing recommender, a fitness-based recommender, a shopping recommender, etc. In an example, given the origin and route destination, the route recommendation orchestrator 202 may provide suggestions for a travel mode based on user preferences and/or context data. If the user is a fitness enthusiast and the weather is conducive, then the route recommendation orchestrator 202 may suggest a hiking/biking route between the origin and the destination. Further, if the weather is cooler, recommendations for warmer clothing may also be generated for the hiking route.

While the recommender systems 206 include individual recommenders that provide a specific type of recommendations as described above, they may also rely on the user data and context data (time, weather, traffic, location, crime data, etc.) for recommendations. For example, a restaurant recommender can be implemented using a Deep Neural network (such as Softmax) as a multiclass prediction problem. It allows the addition of features for providing better context data (location, age, time, etc.). The recommender systems 206 leverage one or more of the plurality of data sources 120 to determine a score for each recommendation and then output top N results. Unlike other recommendation systems (for shopping or watching videos), these recommender systems 206 employed by the route recommendation orchestrator 202 need to be more dynamic since the context data 124 (location, weather, time of the day, traffic, etc.) may be constantly changing.

In addition, context data 124 associated with the user request 182 is also obtained from context data sources 220. The route recommendation orchestrator 202 employs the context data 124 to rank the recommendations. Therefore, various factors from the context data 124 such as the origin/destination combination, mode of travel, time of the day, etc. may be used to rank the recommendations. Therefore, the underlying recommender systems 206 recommend places (restaurants, scenic waypoints, hiking trails on the way, shops, etc.) and the recommendation orchestrator 202 may use the locations associated with the ranked recommendations to identify route suggestions. The locations of the recommended places are provided by the recommendation orchestrator 202 to the routing engine 204 to fetch/receive routes passing through these locations. The routing engine 204 provides the optimal routes given a set of constraints provided by the recommender systems 206. For example, if a recommender system suggests that the user may be interested in a nearby library then the routing engine 204 factors the user preference to recommend a route that passes by the library.

One or more routes received from the routing engine 204 are provided to the navigation Application Programming Interface (API) 210 for a display to the user. If more than one route is identified, the routes may be ranked based, for example, on the number of places of interest each route may touch and all the identified routes may be displayed to the user with the ranks so that the user may select the desired route. The navigation API 210 may be the external interface of the route recommendation orchestrator 202 which user communication devices 192, 194, . . . interact with. The navigation API 210 can receive inputs like start/destination, user metadata, and any other route constraints put by the user to return route recommendations, targeted content to display on the map, and any suggestions before the route starts. The navigation API 210 thus interacts with other components as described above to come up with route recommendations and suggestions.

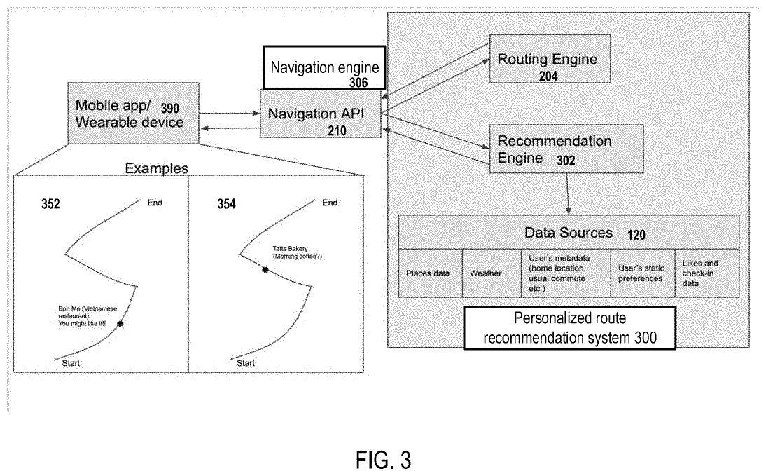

FIG. 3 shows a block diagram of the personalized route recommendation system 300 with sample route displays 352, 354 according to an example. As mentioned above, the personalized route recommendation system 300 is communicatively coupled to the plurality of data sources 120 which may include places data sources (e.g., maps data), weather data source, user's metadata (for example, as gathered from a social media platform), user's static preferences and user behavior data such as likes, check-in data, etc. Although depicted as being internal to the personalized route recommendation system 300, it may be appreciated that the plurality of data sources 120 may be also externally located as shown in FIG. 1A. The personalized route recommendation system 300 includes a navigation engine 306 which may receive a user request for a personalized route from a wearable device 390. The wearable device 390 may host a mobile app to receive user requests and to provide personalized routes.

The recommendation engine 302 included within the personalized route recommendation system 300 may identify the user from the user request 182 and retrieves the user preference data 122 and the context data 124 from the plurality of data sources 120 to generate a ranked list of recommendations for places of interest. The ranked recommendations are provided to the routing engine 204 which identifies the locations associated with the recommendations and builds routes that include the locations pertaining to the recommendations. The navigation engine 306 including the navigation API 210 presents the route(s) identified by the routing engine 304 via the mobile app on the wearable device 390. Example routes 352 and 354 with different locations of interest may be shown to the user who can select one of the routes 352, 354, whereby the navigation engine or a mapping ‘app’ on the wearable device 390 may provide navigation directions for the selected route.

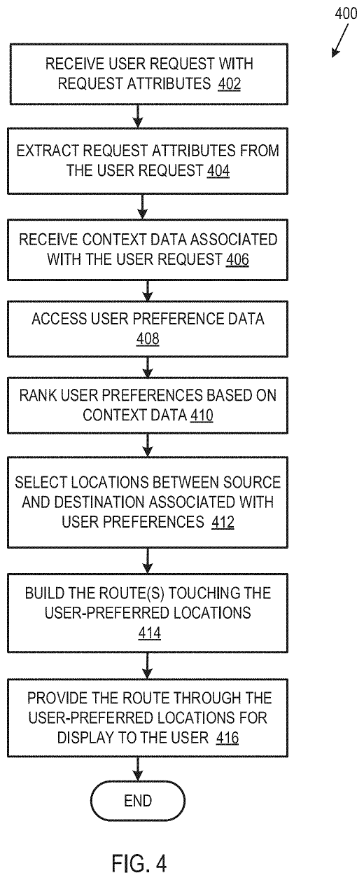

FIG. 4 includes a flowchart 400 that shows a method of providing personalized routes according to an example. The method begins at 402, wherein the user request 182 with the request attributes 184 is received. The request attributes 184 are extracted at 404 and may enable identifying the user. The context data 124 associated with the user request is included at 406 from one or more of the plurality of data sources 120. The user preference data 122 is accessed at 408 based for example on the user identification determined from the request attributes 184. The user preferences obtained from the user preference data 122 are ranked at 410 by applying the context data. The locations associated with top N recommendations (wherein N is a natural number, and N=1, 2, 3 . . . ) are selected at 412. The geographic location data associated with the top recommendations are retrieved and the route the passes through a maximum number of the user preferred locations are built at 414 and provided for display to the user at 416.

Below are discussed certain example use cases:

If shared by the user, the personalized route recommendation system 300 may be aware of the user's home location and general area of commute. If the personalized route recommendation system 300 detects a newer location, the navigation experience can be enriched based on information learned by the personalized route recommendation system 300 about the user's preferences.

Depending on the time of the day and the user's preferences (both learned and static), the personalized route recommendation system 300 can show targeted restaurants on the route map. For example, if the system is aware that the user prefers German Bakeries, it could highlight similarly tagged shops on the map.

Similar concepts can be extended to AR glasses. If a user is navigating through a neighborhood, the personalized route recommendation system 300 can match the user's preferences with the establishments in the vicinity and show targeted suggestions (in form of AR content) or even ads on storefronts.

The personalized route recommendation system 300 can leverage weather data to make suggestions. For example, if it is bitterly cold outside and a user decides to take a walking route, the personalized route recommendation system 300 could caution the user to bundle up. Or if the weather is warmer outside and the user's preferences suggest that the user often goes on hikes, the personalized route recommendation system 300 could suggest a walking route.

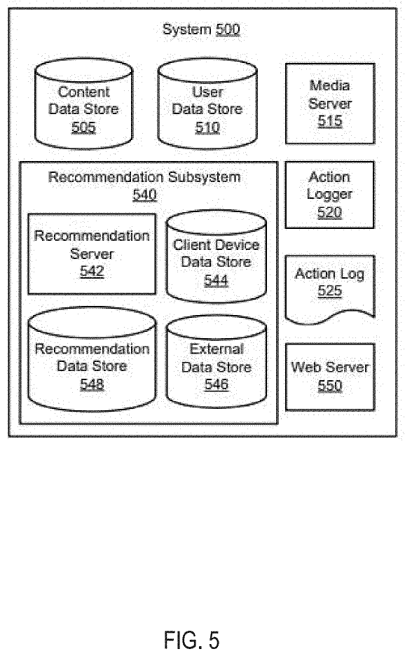

FIG. 5 illustrates a block diagram of a system 500 for providing recommendations, according to an example. The system 500 can be used as one of the recommender systems 206 that enable generation of personalized route recommendations. It should be appreciated that the system 500 may be similar to the system 100 as described with respect with FIG. 1A in that the system 500 may include a processor and a memory which may store a recommendation subsystem 540, but the system 500 may be described with more specificity and/or with examples of additional capabilities and features that may or may not be a part of system 100. In some examples, the system 500 may be an online system (e.g., a social media system) having the recommendation subsystem 540 to help provide search features as well as provide item recommendations for personalized routes in response to user requests from any number of client devices 192, 194, . . . communicatively coupled to the system 100 via the network 160. As shown, the system 500 may include a content data store 505, a user data store 510, a media server 515, an action logger 520, an action log 525, and a web server 550.

The content data store 505 may store a variety of content associated with a search query for an item within a search area, as described herein. As a result, the content data store 505 may involve any digital content associated with searching an item, mapping a geography, advertisements, etc. For example, such content may include digital content media associated with any number of items, such as events, directions, and/or other goods or services to be searched or recommended.

The user data store 510 may also store, among other things, data associated with users. This data may include user profile information directly provided by a user or inferred by the system 500. Examples of such information may include biographic, demographic, pictorial, and/or other types of descriptive information, such as employment, education, gender, hobbies, preferences, location, etc. It should be appreciated that any personal information that is acquired may be subject to various privacy settings or regulations, as described below.

The media server 515 may be used, among other things, to gather, distribute, deliver, and/or provision various digital media content, e.g., stored in the content data store 505 or elsewhere. The media server 515 may be used by system 500 to coordinate with the system 100 of FIG. 1A, for example, which to provide personalized route recommendations to any number of client devices 192, 194, . . . .

The system 500 may also include an action logger 520, an action log 525, and a web server 550. In some examples, the action logger 520 may receive communications about user actions performed on or off the system 100, and may populate the action log 525 with information about various user actions. Such user actions may include, for example, adding a connection to another user or entity, sending a message from another user or entity, viewing content associated with another user or entity (such as another user or an advertisement), initiating a payment transaction, etc. In some examples, the action logger 520 may receive, subject to one or more privacy settings or rules, content interaction activities associated with another user or entity. In addition, a number of actions described in connection with other objects may be directed at particular users, so these actions may be associated those users as well. Any or all of these user actions may be stored in the action log 525.

The system 100 may use the action log 525 to track user actions on the system 100 or other external systems. The action log 525 may also include context information associated with context of user actions. For example, such content information may include date/time an action is performed, other actions logged around the similar date/time period, or other associated actions. Other context information may include user action patterns, patterns exhibited by other similar users, or even various interactions a user may have with any particular or similar object.

The web server 550 may link up with the system 100 via a network (e.g., network 160 of FIG. 1A). The web server 550 may serve web pages, as well as other web-related content, such as Java, Flash, XML, or other similar content. The web server 550 may communicate with various internal elements of the system 500 or external network components to provide various functionalities, such as receiving, transmitting, and/or routing content between the system 500, client devices, and other network elements or components.

As described herein, the system 500 may also include the recommendation subsystem 540. The recommendation subsystem 540 may employ one or more techniques to help define, modify, track, schedule, execute, compare, analyze, evaluate, and/or deploy one or more applications for the system 500. In some examples, the recommendation subsystem 540 may also employ any variety of techniques to provide item recommendations, for instance, using information from client devices 192, 194. In some examples, the recommendation subsystem 540 may include a recommendation server 542, a client device data store 544, a host system data store 546, and a recommendation data store 548.

In particular, the recommendation server 542 of the recommendation subsystem 540 may enable the system 500 to provide any number of item recommendations to client devices 110, as discussed herein. Specifically, the recommendation server 542 may, in some examples, analyze, evaluate, examine, and/or update data associated with any search for an item in or near any search area. Based on these assessments, the recommendation server 542 may identify and/or recommend various items for the client devices 110, where these items may include, but not limited to, events, such as musical events, art events, culinary events, etc.

The recommendation subsystem 540 may use the client device data store 544 to store content associated with client devices 110, and the recommendation data store 548 to store content associated with data and/or any information derived from such any search query or other relevant data, such as recommendation data, historical data, etc.

Although not depicted, it should be appreciated that system 500 may also include various artificial intelligence (AI) based machine learning tools to help provide item recommendations. For example, these AI-based machine learning (ML) tools may be based on optimization of different types of content analysis models, including but not limited to, algorithms that analyze data and potential search results, and other details to provide relevant item recommendations. For instance, these AI-based machine learning tools may be used to generate models and/or classifiers that may include a neural network, a tree-based model, a Bayesian network, a support vector, clustering, a kernel method, a spline, a knowledge graph, or an ensemble of one or more of these and other techniques. These AI-based machine learning tools may further generate a classifier that may use such techniques. The recommendation subsystem 540 may periodically update the model and/or classifier based on additional training or updated data associated with the system 500. It should be appreciated that the recommendation subsystem 540 may vary depending on the type of input and output requirements and/or the type of task or problem intended to be solved. The recommendation subsystem 540, as described herein, may use supervised learning, semi-supervised, and/or unsupervised learning to build the model using data in the training data store. Supervised learning may include classification and/or regression, and semi-supervised learning may require iterative optimization using objection functions to fill in gaps when at least some of the outputs are missing. It should also be appreciated that the recommendation subsystem 540 may provide other types of machine learning approaches, such as reinforcement learning, feature learning, anomaly detection, etc.

It should be appreciated that classification algorithms may provide assignment of instances to pre-defined classes to decide whether there are matches or correlations. Alternatively, clustering schemes or techniques may use groupings of related data points without labels. Use of knowledge graphs may also provide an organized graph that ties nodes and edges, where a node may be related to semantic concepts, such as persons, objects, entities, events, etc., and an edge may be defined by relations between nodes based on semantics. It should be appreciated that, as described herein, the term “node” may be used interchangeably with “entity,” and “edge” with “relation.” Also, techniques that involve simulation models and/or decision trees may provide a detailed and flexible approach to providing item recommendations associated with calculating a search radius based on density, as described herein.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

Systems and methods for optimizations of travel routes that enable generating simpler mapping or route instructions are disclosed. A user request for mapping instructions between an origin and a destination is received. In an example, the user request may pertain to mapping instructions for a pedestrian route. The user request attributes including the origin and destination are used to retrieve an initial route from a mapping database. The initial route is further optimized to eliminate turns or additional points via the application of methodologies used for simplifying polygons such as but not limited to, the Douglas-Peucker algorithm, or other artificial-intelligence (AI) based techniques. Simpler mapping instructions may be generated based on the optimized route.

The Douglas-Peucker method belongs to a class of line simplifying algorithms that may be applied to simplify polygons or other geometric figures to reduce the consumption of processing resources. The initial route may be analyzed to identify different turns and the points associated with the different turns along the initial route. The distance of each of the points from a connecting line defined between the origin and the destination is calculated and compared to a tolerance threshold to determine if the point is to be included or excluded from the optimized route. Therefore, simplifying the initial route in accordance with the examples discussed herein results in fewer turns in an optimized route which not only enables generating simpler instructions but may further enable generating such instructions faster and with fewer processing resources.

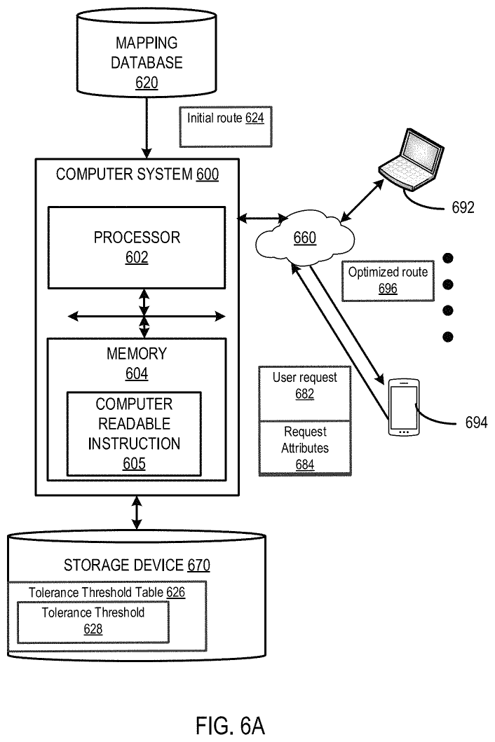

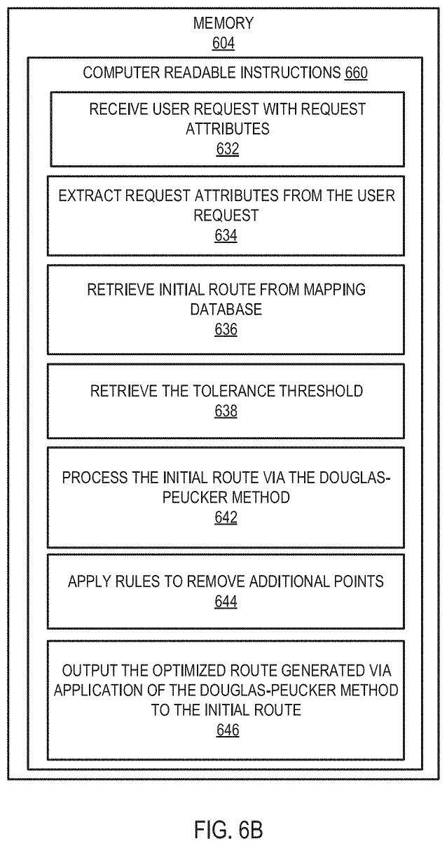

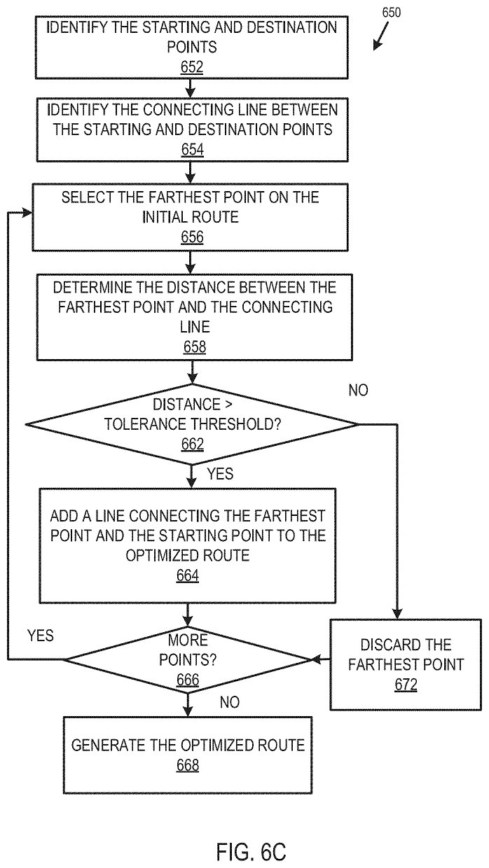

Reference is now made with respect to FIGS. 6A and 6B which illustrate a block diagram of a computer system 600 and a memory 604 included therein that is used for optimized route generation, according to an example. As shown in FIG. 6A the computer system 600 may include a processor 602 and a memory 604. FIG. 6B illustrates a block diagram of the memory 604 including computer-readable instructions 605, that when executed by the processor 602 may be configured to provide optimized routes over user communications devices 692, 694 . . . , etc., according to an example. The user communication devices 692, 694 . . . , etc., may be electronic or computing devices configured to transmit and/or receive data (e.g., via a social media application), and in one example, the user communication devices 692, 694 . . . , etc., may include a smartphone, a laptop, a smartwatch, an Augmented RealityNirtual Reality (ARNR) device. The computer system 600 may also be connected to at least one mapping database 620 such as but not limited to, OpenStreetMap. The mapping database 620 provides the mapping information for generating routing directions for different transportation modes such as for driving, public transport, or pedestrian routes. In the case of pedestrian routing instructions, the mapping database 620 may provide directions via routes that include sidewalks, use pedestrian crossings, or cycling paths, hiking routes, etc. The computer system 600 may also be connected to a storage device 670 that stores data such as information gathered from user requests, location information of users, and other data used during the route optimization as described herein.

The computer system 600 may communicate with the user communication devices 692, 694, . . . , etc., via a network 660 that can be a local area network (LAN), a wide area network (WAN), the Internet, a cellular network, a cable network, a satellite network, or another network. Network 660 may further include one, or any number, of the exemplary types of networks mentioned above operating as a stand-alone network or in cooperation with each other. For example, the network 660 may utilize one or more protocols of one or more clients or servers to which they are communicatively coupled. Network 660 may facilitate the transmission of data according to a transmission protocol of any of the devices and/or systems in the network 660. Although network 660 is depicted as a single network, it should be appreciated that, in some examples, the network 660 may include a plurality of interconnected networks as well.

It should be appreciated that the systems and subsystems shown and described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the servers, systems, subsystems, and/or other computing devices may be shown as single components or elements, it should be appreciated that one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the computer system 600 or the system environment including the computer system 600, the user communication devices 692, . . . , etc.

The computer system 600 may further include the storage device 670. In one example, the storage device 670 may include any number of servers, hosts, systems, and/or databases that store data to be accessed by the computer system 600 or other systems (not shown) that may be communicatively coupled thereto. Also, in one example, the servers, hosts, systems, and/or databases of the storage device 670 may include one or more storage mediums storing any data, and may be utilized to store information (e.g., user information, demographic information, preference information, etc.) relating to users of a social media application facilitating the generation and transmission of optimized routes.

The processor 602 in the computer system 600 may access the computer-readable instructions 605 from the memory 604 to execute various processes that enable the personalized route generation as described herein. In one example, the memory 604 may have stored thereon machine-readable instructions (which may also be termed computer-readable instructions) 605 that the processor 602 may execute. The memory 604 may be an electronic, magnetic, optical, or another physical storage device that contains or stores executable instructions. The memory 604 may be, for example, Random Access Memory (RAM), an Electrically Erasable Programmable Read-Only Memory (EEPROM), a storage device, an optical disc, or the like. The memory 604, which may also be referred to as a computer-readable storage medium, maybe a non-transitory machine-readable storage medium, where the term “non-transitory” does not encompass transitory propagating signals.

More particularly, the processor 602 may execute instructions 632 to receive a user request 682 for a personalized route. The user request 682 may include certain request attributes 684. The request attributes 684 may include at least the origin and destination for the route to be generated. The request attributes may optionally include the mode of transport that the user proposes to employ. In an example, a user may choose to walk in which case, the directions for a pedestrian route are generated as detailed herein.

The processor 602 may execute instructions 634 to extract the request attributes 684 from a user request 682. In an example, the user request 682 may be received via a user interface (UI) put forth by the optimized route generation system 600 so that at least the source, destination values, and a model of transport entered by the user in specific UI elements can be mapped to the corresponding data fields to be extracted from the user request 682.

The processor 602 may execute instructions 636 to retrieve an initial route 624 associated with the user request from the mapping database 620. Mapping databases, such as OpenStreetMap, may provide route data such as data regarding sidewalks, streetlights, etc., along different routes. Upon retrieving the route data, the processor 602 may proceed to optimize the retrieved route to make it easier for the traveler to navigate the route. As mentioned above, the instructions may be out of synchrony with the traveler's position along the route due to sharp turns at corners or short streets where the traveler may have to take multiple turns within a short distance. The system 600 may be configured to optimize the route so that the turns are minimized thereby enabling better synchrony between the instructions and the traveler's position.

In an example, the route optimization via minimizing the turns may include applying the Ramer-Douglas-Peucker, also known as the Douglas-Peucker algorithm, to the initial route 624. The Douglas-Peucker algorithm is an iterative end-point fit algorithm that decimates a curve composed of line segments to a similar curve with fewer points. The algorithm may typically accept a parameter, referred to as a tolerance threshold 626, sometimes also called epsilon, which may be used to determine if a point on the route is to be included or discarded during the optimization process. In an example, the epsilon for a given route may be characteristic of the particular location, e.g., county, district, or city pertaining to the initial route 624. The tolerance threshold 626 may be determined empirically for different locations according to an example. The storage device 670 may store a tolerance threshold table 628 with tolerance thresholds for various locations including the tolerance threshold 626. The processor 602 may execute instructions 638 to retrieve the tolerance threshold 626, or epsilon value.

The processor 602 may execute instructions 642 to process the initial route 624 using the Douglas-Peucker method via an application of the tolerance threshold 626. The initial route 624 may be simplified or points may be included in or removed from any given route based on a tolerance threshold comparison of a distance of the points from a straight line connecting origin and destination. The processor 602 may further execute instructions 644 to remove additional unnecessary points by applying rules as described herein. An optimized route 696 generated by the processor 602 upon processing the initial route 624 via the Douglas-Peucker method may be output by executing the instructions 646. The data regarding the optimized route 696 may be transmitted to the user device 694, which may be initially transmitted the user request 682. The user device 694 may output the route directions based on the optimized route 696 via one or more of audio, textual, video instructions, a combination thereof, or other multimodal data.

FIG. 6C shows a flowchart 650 including the steps of generating an optimized route 696, according to an example. The method may begin at 652, with the processor 602 identifying an origin and a destination of an initial route 624. A connecting line (e.g., a straight line) connecting the origin and the destination may be identified or hypothetically described at 654. A point on the initial route 624 that is farthest from the connecting line may be selected at 656. At 658, the distance between the farthest point and the connecting line may be determined. At 662, it may be determined if the distance between the farthest point and the connecting line is greater than the tolerance threshold 628.

At 662, to determine that the distance between the farthest point and the connecting line is greater than the tolerance threshold 628, a line connecting the farthest point to the starting point/origin may be hypothetically described or added to the optimized route at 664. It is further determined at 666 if any points on the initial route remain for processing. In the event it is determined at 666 that more points remain to be processed, the method may returns to 656 to select the next farthest point on the initial route 624. In the event it is determined at 666 that no more points remain to be processed, the optimized route may be generated at 668, connecting the origin, the farthest point(s) included in the initial route, and the destination.

At 662, to determine that the distance between the farthest point and the connecting line is less than the tolerance threshold 628, the point may also be discarded at 672 and the method returns to 666 to determine if any points on the initial route 624 remain for processing.

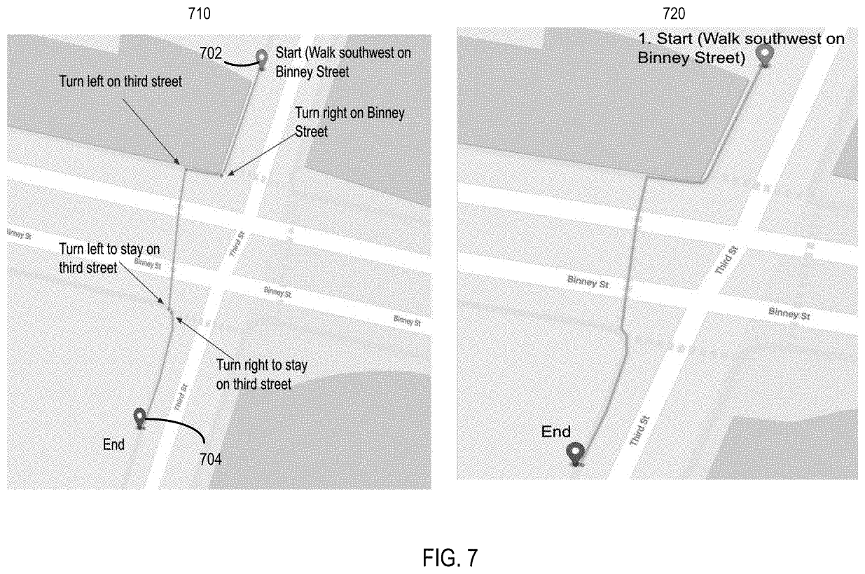

FIG. 7 shows an optimized navigation route, according to an example. On receiving a user request, an initial route 710 may be generated from the origin 702 to the destination 704. In the initial route 710, it be seen that the route may essentially go straight with two extra turns. Turn 2, for example, including the right turn onto Binney Street and turn 3 including the Left turn onto the Third Street, may be included because of the intricate sidewalk or crosswalk geometry. Therefore, only the first turn is needed for generating routing instructions whereas turn 2, and turn 3 may be removed as the user may be able to make these turns depending on the situation along the route/path. Providing additional instructions for such redundant or minor turns may unduly burden or confuse any user. The optimized route 720, then, may be shown to the user with the two extra turns removed. Therefore, the instructions output by the user device 694 or the map shown by the user device 694 providing the instructions after the route optimization by the system 100 may show the optimized route 720 as opposed to the initial route 710.

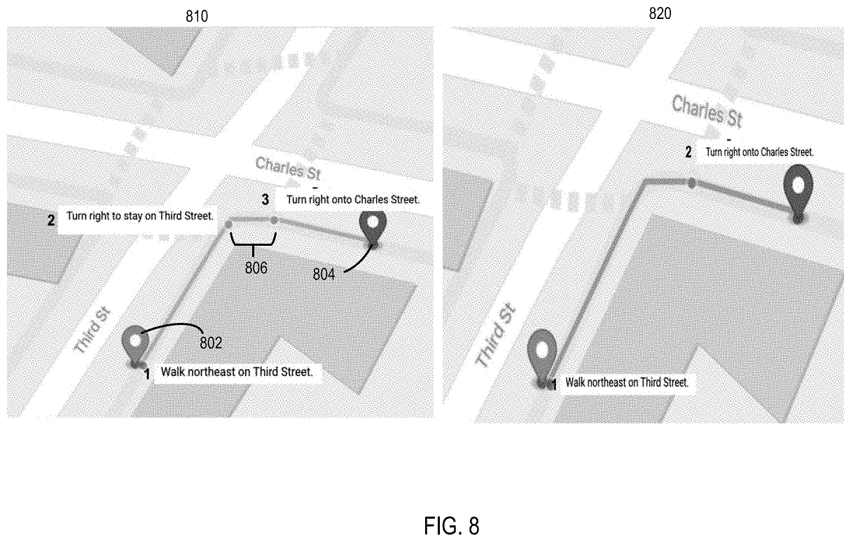

FIG. 8 shows another optimized route navigation, according to an example. The initial route 810 has two consecutive turns. The first direction instructs the user to walk northeast from the starting point 802 on the Third Street, the second direction instructs the user to take turn 2—a right turn on the Third Street and the third direction instructs the user to take turn 3—a right turn onto Charles Street. While the first and last turns or directions have different street names but either the first two turns or the last two turns have the same names (i.e., Third Street or Charles Street) and the length of middle turn 806 may be below the tolerance threshold. In this case, the system 100 may deduce that the route is taking just one right or left turn as opposed to two turns. The extra turn, i.e., the middle turn 806, may be an artifact of the sidewalk geometry and hence the middle turn 806 may be removed from the optimized route 820. Therefore, routing instructions to the user based on the simplified or optimized route 820 are simpler as they eliminate a few turns as compared to the instructions that would have been generated based on the initial route 810. It should be appreciated that this tolerance threshold may be tunable. In others words, the tolerance threshold may be adjusted based on average length of sidewalk corners in a particular city/area for this example. However, in most cases, a tolerance of seven (7) or eight (8) meetings may generally suffice.

The route optimization or simplification systems and methods described herein may, in some examples, be implemented as post-processing steps after the route path has been selected and may be implemented in any geo-navigation routing engine using any programming language. The route optimization or simplification systems and methods may also be agnostic of the data source, i.e., regardless of whether the mapping data is open data source, such as OpenStreetMap or collected through a private sources stored in a proprietary format. The route optimization techniques described herein may enable improved technical correctness and usability of different route types, e.g., pedestrian routes. In addition to sidewalks and crosswalks, these concepts may be extended to cycling or hiking trails as well, to improve cycling or hiking navigation. It should be appreciated that pedestrian navigation is still a very nascent field and the route optimization as described herein may provide improved route navigation using optimized route geometry, which in turn generating simple, accurate navigational instructions for any user.

Although examples described herein are generally directed to pedestrian navigation, the systems and methods may also be used in any number of navigation based systems, such as driving, flying, swimming, cycling, or other activity. Furthermore, the systems and methods may incorporate other various AI-based techniques, in addition to the Douglas-Peucker method, described herein. Any AI-based, machine-learned, or statistics-based technique to simplify route navigation mays also be used.

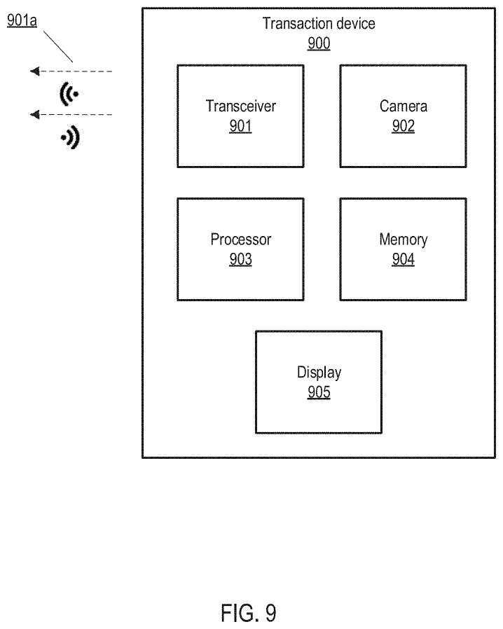

FIG. 9 illustrates a block diagram of a transaction device 900, according to an example. In some examples, the transaction device 900 may be configured to, among other things, utilize directed transmission(s) of signals to initiate, authenticate and facilitate a secure transaction between a first transaction device and a second transaction device. As illustrated in FIG. 9, in some examples, the transaction device 900 may include (among other things) a transceiver 901, a camera 902, a processor 903, a memory 904 and a display 905.

In some examples, the transaction device 900 may be a mobile device that may embody a small(er) form factor, such as a handheld computing device that may be utilized by a customer to conduct a transaction (e.g., a purchase of a good or service). In one example, the transaction device may be augmented reality (AR)/virtual reality (VR)/mixed reality glasses that may be worn by a customer seeking to conduct a transaction in a brick and mortar store.

In some examples, the transaction device 900 may or may not include additional features, and some of the features described herein may be removed and/or modified without departing from the operations described herein. In some examples and as further discussed below, the transaction device 900 may communicate with one or more other devices via a wired or wireless network.

The transceiver 901 may transmit and receive data wirelessly using an antenna for communication purposes. In particular, in some examples, the transceiver 901 may transmit a pairing signal or transaction data to another transaction device to facilitate a transaction. As used herein, “transaction data” may include any data associated with a transaction. In some examples, the transaction data may include supplemental information.

In some examples, the transceiver 901 may be configured to transmit any number of types of wireless signals. In a first example, the transceiver 901 may transmit infrared (IR) signals. In another example, the transceiver 901 may transmit Bluetooth™ signals. Indeed, it should be appreciated that the transceiver 901 may be configured to transmit or receive wireless signals utilizing any number of transmission protocols (e.g., 3G, 4G, LTE, 5G, etc.).

In some examples, the transceiver 901 may be configured to transmit a wireless signal (e.g., an infrared (IR) signal) over a limited scope and within a limited area so as to enable a directed projection of the wireless signal. In one example, the wireless signal may be a narrow-beam signal 901a. As discussed above, the narrow-beam signal 901a may be utilized to initiate, authenticate and facilitate a transaction between a first transaction device and a second transaction device.

In some examples, the narrow-beam signal 901a transmitted by the transceiver 901 may be coupled with directionality to facilitate a transaction. As used herein, “directionality” may include directing of a wireless signal (e.g., by a user) to a particular location on another device so as to initiate and/or conduct a transaction. In some examples, the narrow-beam transmission from the first transaction device 900 may be utilized to generate a “line of sight” for the transaction device 900 that may be used to direct a wireless signal toward another transaction device. So, in one example, a customer wearing augmented reality (AR)/virtual reality (VR)/mixed reality glasses may direct the narrow-beam signal 901a to a particular location by looking directly at the particular location.

In some examples, the narrow-beam signal 901a transmitted by the transceiver 901 may be directed (i.e., focused) onto a particular location of associated with a second transaction device, wherein receipt of the wireless signal by the second transaction device may be utilized to initiate and/or conduct a transaction between the transaction device 900 and the second transaction device. Accordingly, in this manner, the transceiver 901 may be utilized, in some examples, to enable particular, limited, and/or private information (i.e., data) to be transmitted or received by the transaction device 900.

Moreover, in some examples, line of sight created by narrow-beam transmission may be utilized to distinguish between one or more devices in a proximity. So, in one example, where the transaction device 900 may be in proximity of a second transaction device, a third transaction device and a fourth transaction device, a line of sight with respect to a transceiver located on the transaction device 900 may be utilized to distinguish between transaction devices and maintain communication with an appropriate device.

The camera 902 may be an optical device that may capture a visual image in digital data. In particular, in some examples, the camera 902 may be utilized to direct transmission of a signal, such as an infrared signal, from the transaction device 900 to another transaction device.

In some examples, the processor 903 may execute the machine-readable instructions stored in the memory 904. It should be appreciated that the processor 903 may be a semiconductor-based microprocessor, a central processing unit (CPU), an application specific integrated circuit (ASIC), a field-programmable gate array (FPGA), and/or other suitable hardware device.

In some examples, the memory 904 may have stored thereon machine-readable instructions (which may also be termed computer-readable instructions) that the processor 903 may execute. The memory 904 may be an electronic, magnetic, or other physical storage device that contains or stores executable instructions. The memory 904 may be, for example, Random Access memory (RAM), an Electrically Erasable Programmable Read-Only Memory (EEPROM), a storage device, or the like. The memory 904, which may also be referred to as a computer-readable storage medium, may be a non-transitory machine-readable storage medium, where the term “non-transitory” does not encompass transitory propagating signals.

Furthermore, it should be appreciated that the memory 904 depicted in FIG. 9 may be provided as an example. Thus, the memory 904 may or may not include additional features, and some of the features described herein may be removed and/or modified without departing from the scope of the memory 904 outlined herein. Also, it should be appreciated that, the processing performed via the instructions on the memory 904 may or may not be performed, in part or in total, with the aid of other information and data, such as information and data provided by other coupled devices.

The display 905 may visually display digital data, such information related to a transaction to be conducted. In some examples, the display 905 may include a touch screen or non-touch screen display for user input and/or output.

In many instances, a customer seeking to purchase a good or service may be required to provide various information to facilitate a transaction. As used herein, a “transaction” may include any communication between a first transaction device and a second transaction device. Examples may include the customer's name, payment information, and associated authentication information. As used herein, a “transaction device” may include any computing that may be configured to receive and transmit data. Examples may include mobile phones, smartwatches, and augmented reality (AR)/virtual reality (VR)/mixed reality (MR) glasses.

However, in some instances, it may be efficient and/or convenient to for a user to access and provide supplemental information to aid in conducting a transaction. Examples may include the customer's browsing history, purchase history, and preferences (i.e., likes). As used herein, “supplemental information” may include any information that may be related to a transaction and that may utilize to facilitate or help process any given transaction.

By way of example, in one instance, a customer seeking purchase paint for their home may have browsed for and selected one or more particular color(s). At this point, the customer may arrive at a brick and mortar store to complete the purchase of the particular color(s) of paint. However typically, to complete the transaction, the customer may need to manually input specification information for each of the particular color(s) of paint, which may be inefficient and less than convenient for the customer.

In another example, a customer seeking to enjoy a meal at a brick and mortar eatery may order their meal at kiosk. In some instances, it may be convenient for the customer (and efficient for the proprietor) to automatically access information related to the customer's prior purchases. However typically, this may not be available, and instead the customer may have to remember the item they prefer and search for it on a menu.

It should be appreciated that a proliferation of personal user devices, such as mobile phones and wearables (e.g., smart watch, virtual reality (VR) headset, augmented reality (AR) glasses, etc.), may have provided an opportunity to utilize these personal user devices to transfer supplemental information that may be used to facilitate a transaction. Systems and methods to utilize directed transmission of wireless signals to initiate, authenticate and facilitate a secure transaction between a first transaction device and a second transaction device are described herein. In some examples, a first transaction device may enter a proximity of a second transaction device, wherein the second transaction device may detect that the first transaction device may be in the proximity of the second transaction device. As used herein, “proximity” of a transaction device may include a distance that may be sufficient for the first transaction device and the second transaction device to transfer data.

Upon detecting that the first transaction device may be within the proximity, the second transaction device may transmit a pairing signal to initiate communication between the first transaction device and the second transaction device. Upon receiving the first pairing signal from the second transaction device, the first transaction device may send a pairing signal (i.e., response) back to the second transaction device that may confirm communication between the first transaction device and second transaction device. In some examples, upon confirming communication, the first transaction device and the second transaction device may send any information, including supplemental information, securely to the second transaction device to facilitate a transaction.

In some examples, the systems and methods may implement directed transmission of wireless signals to facilitate a transaction. In particular, in some examples and as discussed further below, the systems and methods may utilize transmission of wireless signals in a particular direction to initiate a pairing to facilitate a transaction between the first transaction device and the second transaction device.

In some examples, the systems and methods may utilize one or more devices configured to transmit a wireless signal that may cover a limited scope. That is, the wireless signal may be transmitted over a particular and/or limited area or region to enable a directed projection of the wireless signal. In some examples and as used herein, this transmission may be referred to as a “narrow-beam” transmission. In some examples and as discussed further below, the narrow-beam transmission may be utilized to authenticate and/or pair a first transaction device and a second transaction device and to transmit data (e.g., supplemental data) to facilitate a transaction between the first transaction device and the second transaction device.

In some examples, the systems and methods may include use of a wireless network. In particular, in some examples, the systems and methods may implement a low-power wireless network (LPWN) to identify a first transaction device that may be within an operating range (i.e., “within range”) of a second transaction device. Upon recognizing that the first transaction device may be within range of the second transaction device, the second transaction device may initiate an authentication and/or a pairing process with the first transaction device.

It should be appreciated that the systems and methods described herein may be implemented with any number of types of computing devices. In particular, the systems and methods may be implemented utilizing and/or in conjunction with consumer electronic devices such as mobile phones, wearables (e.g., smart watches, glasses, etc.), headphones and any other similar examples of “smart” devices.

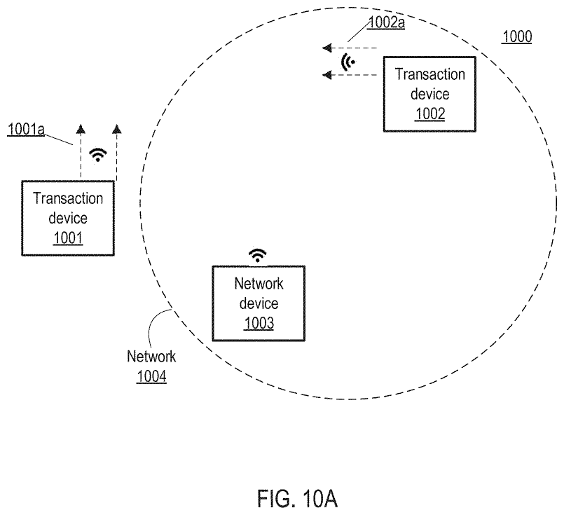

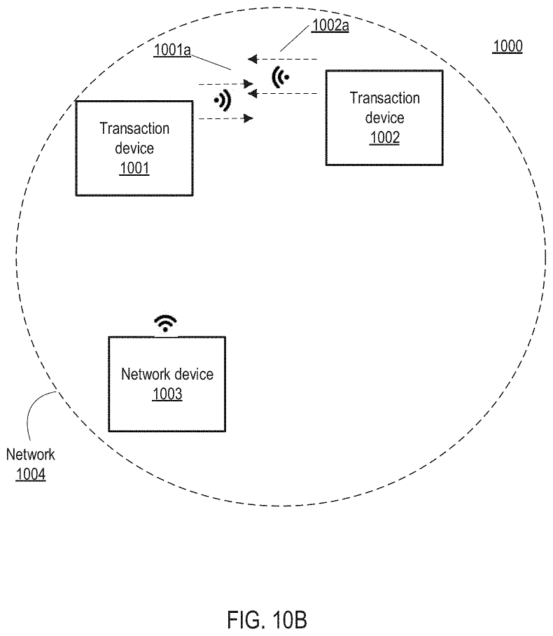

Reference is now made to FIGS. 10A-B. FIG. 10A illustrates a diagram a system environment 1000 including a plurality of transaction devices in a first configuration, according to an example. FIG. 10B illustrates a diagram a system environment 1000 including a plurality of transaction devices in a second configuration, according to an example. In some examples, the system environment 1000 illustrated in FIGS. 10A-10B may include a transaction device 1001, a transaction device 1002 and a network device 1003. As will be described in the examples below, one or more of the transaction device 1001, the transaction device 1002 and network device 1003 as shown in FIGS. 10A-10B may be operated by a service provider to utilize directed transmission(s) of signals to initiate, authenticate and facilitate a transaction between a first transaction device and a second transaction device.

It should be appreciated that one or more of the transaction device 1001, the transaction device 1002 and the network device 1003 depicted in FIGS. 10A-10B may be provided as examples. Thus, one or more of the transaction device 1001, the transaction device 1002 and the network device 1003 may or may not include additional features and some of the features described herein may be removed and/or modified without departing from the scopes of the transaction device 1001, the transaction device 1002 and the network device 1003 outlined herein. Also, in some examples, the network device 1003 may be included in the transaction device 1001 or the transaction device 1002, while in other examples the transaction device 1001 or the transaction device 1002 may be included in the network device 1003. Moreover, in some examples, the transaction device 1001, the transaction device 1002 and the network device 1003 may be or associated with a social networking system, a content sharing network, an advertisement system, an online system, and/or any other system that facilitates any variety of digital transactions in personal, social, commercial, financial, and/or enterprise environments.

While the transaction device 1001, the transaction device 1002 and the network device 1003 shown in FIGS. 10A-10B may be shown as single components or elements, it should be appreciated that one of ordinary skill in the art would recognize that these single components or elements may represent multiple components or elements, and that these components or elements may be connected via one or more networks. Furthermore, in some examples, servers, systems, platforms, and applications not shown may also be provided to facilitate the features and functionalities of the transaction device 1001, the transaction device 1002 and the network device 1003.

In some examples, the transaction device 1001 and the transaction device 1002 may be similar to the transaction device 100 shown in FIG. 1. For example, in some instances, each of the transaction device 1001 and the transaction device 1002 may include a wireless transceiver that may be used to communicate wirelessly. Also, in some examples, the transceiver of the transaction device 1001 and the transceiver of the transaction device 1002 may be configured to communicate via infrared (IR) signals.

Moreover, in some examples, the transaction device 1001 and the transaction device 1002 may be configured to communicate utilizing narrow-beam transmission. In particular, the transaction device 1001 may transmit a narrow-beam signal 1001a and the transaction device 1002 may transmit a narrow-beam signal 1002a. By utilizing a narrow-beam transmission as described, one of the transaction device 1001 and the transaction device 1002 may be able to direct a wireless signal to a particular location on another of the transaction device 1001 and the transaction device 1002 to initiate and/or conduct a transaction. In some examples, the narrow-beam signal 1001a and the narrow-beam signal 1002a may be infrared (IR) signals.

In some examples, the network device 1003 may be utilized to generate facilitate a network 1004. In some examples, the network 1004 may implement one or more Wi-Fi protocols. In operation, one or more of the transaction device 1001 and the transaction device 1002 and the network device 1003 may communicate via the network 1004. Although the network 1004 is depicted as a single network, it should be appreciated that, in some examples, the network 1004 may include a plurality of interconnected networks as well. Also, in some examples, the network 1004 may be coupled to a local area network (LAN), a wide area network (WAN), the Internet, a cellular network, a cable network, or other network that may facilitate communication between, the transaction device 1001, the transaction device 1002 and the network device 1003.

In some examples, the network 1004 may be utilized to detect a first transaction device within proximity of a second transaction device. In particular, since in some instances a transaction device may be too limited in power to continuously “beacon” for other devices, the network 1004 may instead be utilized to detect a transaction device within the network 1004. Accordingly, in some examples, the network 1004 may be continuously checking for (i.e., detecting) transaction devices within its proximity.

In some examples, upon (initial) detection of a first transaction device within the network 1004, a second transaction device within the network 1004 may begin a pairing process to communicate with the first transaction device. In these examples, a notification may be sent to a user that the first transaction device may be in proximity of the second transaction device and that a pairing process may have begun. So, in one example, a user may receive an audio message on a transaction device (e.g., the first transaction device) that may provide information and/or instructions to the user (e.g., “Please direct your attention to the nearby terminal to complete your transaction for $19.99.”). In other examples, the network 1004 may be used to facilitate a pairing process by transmitting data (e.g., a pairing beacon) between the first transaction device and the second transaction device.

So, in the example configuration illustrated in FIG. 10A, the transaction device 1002 may be within (i.e., in communication with) the network 1004, and the transaction device 1001 may be outside (i.e., not in communication with) the network 1004. Moreover, as illustrated in FIG. 10A, the directionality of the transaction device 1001 and the transaction device 1002 may not be matching, in that a line-of-sight created by narrow-beam signal 1001a of the transaction device 1001 may not “meet” a line-of-sight created by the narrow-beam signal 1002a of the transaction device 1002. As a result, in some examples, the transaction device 1002 may not initiate a pairing process to pair with the transaction device 1001.

Now, in the example configuration illustrated in FIG. 10B, the transaction device 1001 may have entered (i.e., be within) the network 1004. In particular, the network 1004 may have detected a presence of the transaction device 1001. Moreover, as illustrated in FIG. 10B, the directionality of the transaction device 1001 and the transaction device 1002 may match, in that a line-of-sight created by the narrow-beam signal 1001a of the transaction device 1001 may now “meet” a line-of-sight created by the narrow-beam signal 1002a of the transaction device 1002.

In some examples, upon detection of the transaction device 1001, the transaction device 1002 may initiate a pairing process directed at the transaction device 1001. In some examples, the pairing process may include beaconing, wherein the transaction device 1002 may transmit a beacon (e.g., an infrared (IR) beacon) to the transaction device 1001 that may affect a solicitation to “pair” with the transaction device 1002. So, as shown in FIG. 10B, the narrow-beam signal 1002a of the transaction device 1002 may be directed toward the transaction device 1001 and may be received by a transceiver located on the transaction device 1001 to initiate a pairing process.

So, in some examples, upon receiving the beacon from the transaction device 1002, the transaction device 1001 may be enabled (e.g., via a prompt) to pair with the transaction device 1002. To pair with the transaction device 1002, a transceiver on the transaction device 1001 may return an indication to pair (e.g., via use of an infrared (IR) signal) to the transaction device 1002. Upon pairing, the transaction device 1001 and the transaction device 1002 may transmit to each other to conduct a transaction.

In some examples, and as discussed above, the transaction device 1001 and the transaction device 1002 may implement directionality to communicate. That is, in some examples, the transaction device 1001 may maintain directionality with respect to transmission of a wireless signal to the transaction device 1002 in order to conduct a transaction. More particularly, in some examples, the transaction device 1001 may transmit a wireless signal to a particular location associated with the transaction device 1002 to conduct the transaction. Similarly, the transaction device 1002 may also maintain directionality with respect to transmission of a wireless signal to the transaction device 1001 in order to conduct the transaction.

It should be appreciated that, in some examples, data may be transferred between the transaction device 1001 and the transaction device 1002 as long as directionality may be maintained. Moreover, it should further be appreciated that the data that may be transferred between the transaction device 1001 and the transaction device 1002 may be encrypted and/or serialized.

In some examples, the transaction device 1002 may transmit a beacon a plurality of times (i.e., “tries”) in order to establish communication with the transaction device 1001. Also, in some examples, the transaction device may implement a counter that may increment for each time a beacon may be transmitted. In some examples, a pairing process by the transaction device 1002 may end after a beacon may have been transmitted a predetermined number of times (i.e., a threshold).

In one example, the transaction device 1001 may be a mobile phone, and the transaction device 1002 may be a kiosk located in a brick and mortar clothing store. In this example, a user looking to purchase an item of clothing and utilizing the transaction device 1001 may assent to pairing with the transaction device 1002. Upon pairing, the transaction device 1002 may request browsing information from an internet browser located on the transaction device 1001. In some examples, the browsing information may be encrypted prior to transmission to the transaction device 1002. It should be appreciated that the provided browsing information may be stored on the transaction device 1001, or otherwise may also be accessed from a remote device and provided to the transaction device 1002 as well. Upon receiving the browsing information from the transaction device 1001, the transaction device 1002 may, in some examples, decrypt and analyze the browsing information to determine one or more clothing items to recommend to the user. In some examples, the recommended items may be displayed on the kiosk to enable the user to complete a purchase. Also, in some examples, the transaction device 1002 may transmit the recommended items to the transaction device 1001 for display. In some examples, the recommended items may be encrypted by the transmission device 1002 prior to transmission.

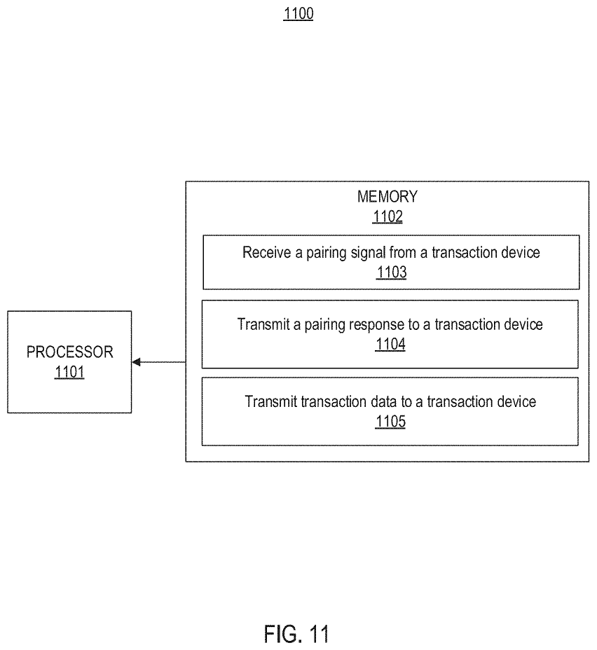

FIG. 11 illustrates a block diagram of a transaction device 1100, according to an example. Similar to the transaction device 900 shown in FIG. 9, the transaction device 1100 may include (among other things) a processor 1101 and the memory 1102, wherein the processor 1101 may be configured to execute the machine-readable instructions stored in the memory 1102.

In some examples, the memory 1102 may store instructions, which when executed by the processor 1101, may cause the processor to: receive 1103 a pairing signal from a transaction device; transmit 1104 a pairing response to a transaction device; and transmit 1105 transaction data to a transaction device. As discussed further below, in some examples, the instructions 1103-1105 on the memory 1102 may be executable by the processor 1101 to implement directed transmission of signals to initiate, authenticate and facilitate a secure transaction between a first transaction device and a second transaction device.

In some examples, the instructions 1103 may receive a pairing signal from a transaction device. So, in some examples, upon reaching a proximity of another transaction device, the instructions 1103 may be configured to receive the pairing signal from the another transaction device.

In some examples, the instructions 1103 may further implement an authentication process prior to enabling a pairing with another transaction device. So, in some examples, the instructions 1103 may require the transaction device 1100 to be scanned by or contacted with the another transaction device. In other examples, the instructions 1103 may enable a passcode to be entered to request a pairing signal prior to transmitting to the another device.

In some examples, the instructions 1104 may transmit a pairing response to a transaction device. So, upon receiving a pairing signal from another transaction device, the instructions 1104 may be configured to transmit a pairing response. In some examples, the instructions 1104 may provide a prompt to enable the pairing.

In some examples, the instructions 1105 may transmit transaction data to a transaction device. In some examples, upon pairing with a transaction device, the instructions 1105 may be configured to transmit transaction data to the another transaction device in order to conduct a transaction. In some examples, the transaction data may be encrypted and/or serialized.

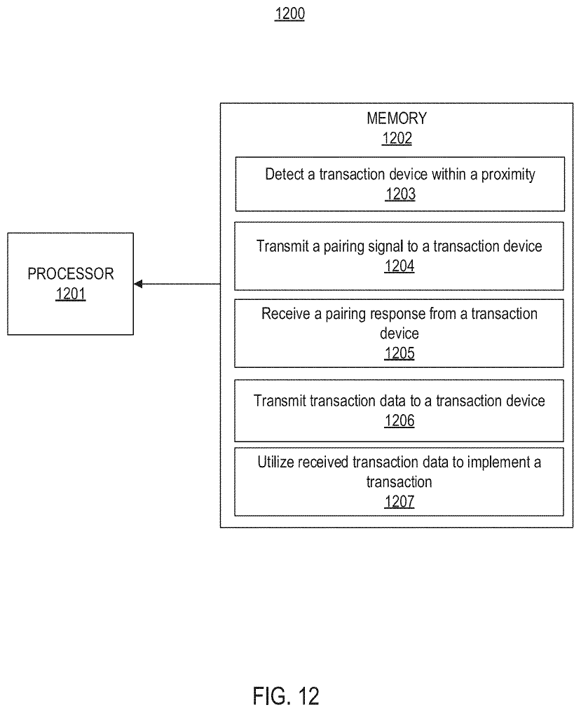

FIG. 12 illustrates a block diagram of a transaction device 1200, according to an example. Similar to the transaction device 900 shown in FIG. 9, the transaction device 1200 may include (among other things) a processor 1201 and the memory 1202, wherein the processor 1201 may be configured to execute the machine-readable instructions stored in the memory 1202.

The memory 1202 may store instructions, which when executed by the processor 1201, may cause the processor to: detect 1203 a transaction device within an operating proximity; transmit 1204 a pairing signal to a transaction device; receive 1205 a pairing response from a transaction device; transmit 1206 transaction data to a transaction device; and utilize 1207 received transaction data to conduct a transaction. In some examples, the instructions 1203-1207 on the memory 1202 may be executable by the processor 1201 to utilize directed transmission(s) of signals to initiate, authenticate and facilitate a secure transaction between a first transaction device and a second transaction device.

In some examples, the instructions 1203 may detect a transaction device within proximity. It should be appreciated that, in some examples, to detect the another transaction device, the transaction device 1200 may be notified of a presence of the another transaction device.

In some examples, the instructions 1204 may transmit a pairing signal to a transaction device. So, in some examples, the instructions 1204 may initiate a pairing process, wherein the pairing process may include beaconing via use of a beacon (e.g., an infrared (IR) beacon). Also, in some examples, the instructions 1204 may transmit a beacon a plurality of times (i.e., “tries”) to establish communication with the another transaction device.

In some examples, the instructions 1204 may utilize a time threshold to transmit a pairing beacon. That is, in some examples and upon detecting another transaction device within proximity, the instructions 1204 may wait a predetermined period of time (e.g., five seconds) prior to transmitting to pairing beacon.

In some examples, the instructions 1205 may receive a pairing response from a transaction device. In some examples, the pairing response may indicate an assent or dissent to pairing with the another transaction device.

In some examples, the instructions 1206 may transmit transaction data to another transaction device. In one example, the instructions 1206 may transmit a request to receive browsing history from a browser located on the another device. In some examples, the request may be encrypted and/or serialized when transmitted.

In some examples, the instructions 1207 may utilize transaction data received from another transaction device to implement a transaction. So, in one example, upon receiving a browsing history from a browser located on the another transaction device, the instructions 1207 may analyze the browsing history to recommend one or more products that may be of interest to a user of the another transaction device.

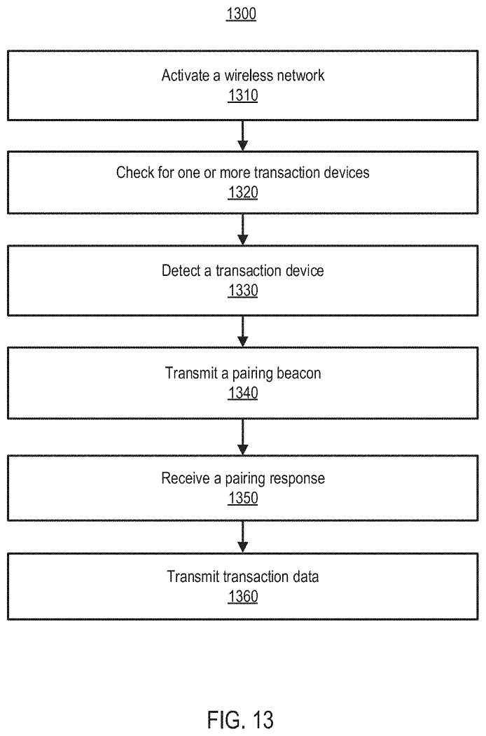

FIG. 13 illustrates a method 1300 for utilizing directed transmission of wireless signals to initiate, authenticate and facilitate a secure transaction between a first transaction device and a second transaction device, according to an example. The method 1300 is provided by way of example, as there may be a variety of ways to carry out the method described herein. Each block shown in FIG. 13 may further represent one or more processes, methods, or subroutines, and one or more of the blocks may include machine-readable instructions stored on a non-transitory computer-readable medium and executed by a processor or other type of processing circuit to perform one or more operations described herein. Although the method 1300 is primarily described as being performed by system 1100 as shown in FIG. 11, the method 1300 may be executed or otherwise performed by other systems, or a combination of systems.

At 1310, the processor 903 may activate a wireless network that may be used to detect a transaction device in proximity. In some examples, the wireless network may be a low-power wireless network (LPWN).

At 1320, the processor 903 may check for one or more transaction devices within proximity of the wireless network. In some examples, the processor may maintain a “list” of devices that may be within range of the wireless network.

At 1330, the processor 903 may detect a transaction device. In one example, the transaction device detected may be a mobile phone.

At 1340, the processor 903 transmit a pairing beacon to a detected transaction device. In some examples, the processor 903 may transmit the pairing beacon utilizing a counter, wherein the pairing beacon may be transmitted periodically and upon each transmission, the counter may be incremented. In some examples, if the processor 903 may not receive a response from the transaction device after a predetermined number of tries, the processor 903 my cease transmission of the pairing beacon.

At 1350, the processor 903 may receive a pairing response from a transaction device. That is, in some examples, the processor 903 may receive a response either assenting or dissenting to pairing with the transaction device 100.

At 1360, upon pairing with another transaction device, the processor 903 may transmit transaction data. In some examples, the transaction data may be serialized and/or encrypted. In one example, the processor 903 may transmit a request for a browsing history from a browser located on another transaction device.

Although the methods and systems as described herein may be directed mainly to electronic commerce, such as videos or interactive media, it should be appreciated that the methods and systems as described herein may be used for other types of scenarios as well. Other applications or uses of the methods and systems as described herein may also include social networking, marketing, digital content, content-based recommendation engines, and/or other types of knowledge or data-driven systems.

It should be noted that the functionality described herein may be subject to one or more privacy policies, described below, enforced by the local systems, the user communication devices 192, 194, . . . etc., and the storage device 170, may bar the use of information obtained from one or more of the plurality of data feeds.

In particular examples, one or more objects of a computing system may be associated with one or more privacy settings. The one or more objects may be stored on or otherwise associated with any suitable computing system or application, such as, for example, the computer system 100, the user communication devices 192, 194, . . . etc., and the storage device 170, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the computer system 100, the user communication devices 192, 194, . . . etc., and the storage device 170 or shared with other systems. Although this disclosure describes using particular privacy settings in a particular manner, this disclosure contemplates using any suitable privacy settings in any suitable manner.

In particular examples, the computer system 100, the user communication devices 192, 194, . . . etc., and the storage device 170 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the computer system 100, the user communication devices 192, 194, . . . etc., and the storage device 170 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics. As an example and not by way of limitation, a first user may specify that other users who attend the same university as the first user may view the first user's pictures, but that other users who are family members of the first user may not view those same pictures.

In particular examples, the computer system 100, the user communication devices 192, 194, . . . etc., and the storage device 170 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the computer system 100, the user communication devices 192, 194, . . . etc., and the storage device 170 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The computer system 100, the user communication devices 192, 194, . . . etc., and the storage device 170 may access such information in order to provide a particular function or service to the first user, without the computer system 100, the user communication devices 192, 194, . . . etc., and the storage device 170 having access to that information for any other purposes. Before accessing, storing, or using such objects or information, the computer system 100, the user communication devices 192, 194, . . . etc., and the storage device 170 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the computer system 100, the user communication devices 192, 194, . . . etc., and the storage device 170.

In particular examples, a user may specify whether particular types of objects or information associated with the first user may be accessed, stored, or used by the computer system 100, the user communication devices 192, 194, . . . etc., and the storage device 170. As an example and not by way of limitation, the first user may specify that images sent by the first user through the computer system 100, the user communication devices 192, 194, . . . etc., and the storage device 170 may not be stored by the computer system 100, the user communication devices 192, 194, . . . etc., and the storage device 170. As another example and not by way of limitation, a first user may specify that messages sent from the first user to a particular second user may not be stored by the computer system 100, the user communication devices 192, 194, . . . etc., and the storage device 170. As yet another example and not by way of limitation, a first user may specify that all objects sent via a particular application may be saved by the computer system 100, the user communication devices 192, 194, . . . etc., and the storage device 170.

In particular examples, privacy settings may allow a first user to specify whether particular objects or information associated with the first user may be accessed from the computer system 100, the user communication devices 192, 194, . . . etc., and the storage device 170. The privacy settings may allow the first user to opt in or opt out of having objects or information accessed from a particular device (e.g., the phone book on a user's smart phone), from a particular application (e.g., a messaging app), or from a particular system (e.g., an email server). The computer system 100, the user communication devices 192, 194, . . . etc., and the storage device 170 may provide default privacy settings with respect to each device, system, or application, and/or the first user may be prompted to specify a particular privacy setting for each context. As an example and not by way of limitation, the first user may utilize a location-services feature of the computer system 100, the user communication devices 192, 194, . . . etc., and the storage device 170 to provide recommendations for restaurants or other places in proximity to the user. The first user's default privacy settings may specify that the computer system 100, the user communication devices 192, 194, . . . etc., and the storage device 170 may use location information provided from one of the user communication devices 192, 194, . . . etc., of the first user to provide the location-based services, but that the computer system 100, the user communication devices 192, 194, . . . etc., and the storage device 170, may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The computer system 100, the user communication devices 192, 194, . . . etc., and the storage device 170 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the computer system 100, the user communication devices 192, 194, . . . etc., and the storage device 170 may use a user's previous activities and calculated moods, emotions, or sentiments to determine a present mood, emotion, or sentiment. A user who wishes to enable this functionality may indicate in their privacy settings that they opt in to the computer system 100, the user communication devices 192, 194, . . . etc., and the storage device 170 receiving the inputs necessary to determine the mood, emotion, or sentiment. As an example and not by way of limitation, the computer system 100, the user communication devices 192, 194, . . . etc., and the storage device 170 may determine that a default privacy setting is to not receive any information necessary for determining mood, emotion, or sentiment until there is an express indication from a user that the computer system 100, the user communication devices 192, 194, . . . etc., and the storage device 170 may do so. By contrast, if a user does not opt in to the computer system 100, the user communication devices 192, 194, . . . etc., and the storage device 170 receiving these inputs (or affirmatively opts out of the computer system 100, the user communication devices 192, 194, . . . etc., and the storage device 170 receiving these inputs), the computer system 100, the user communication devices 192, 194, . . . etc., and the storage device 170 may be prevented from receiving, collecting, logging, or storing these inputs or any information associated with these inputs. In particular examples, the computer system 100, the user communication devices 192, 194, . . . etc., and the storage device 170 may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the computer system 100, the user communication devices 192, 194, . . . etc., and the storage device 170 may use the user's mood, emotion, or sentiment to provide newsfeed items, pages, friends, or advertisements to a user. The user may specify in their privacy settings that the computer system 100, the user communication devices 192, 194, . . . etc., and the storage device 170 may determine the user's mood, emotion, or sentiment. The user may then be asked to provide additional privacy settings to indicate the purposes for which the user's mood, emotion, or sentiment may be used. The user may indicate that the computer system 100, the user communication devices 192, 194, . . . etc., and the storage device 170 may use his or her mood, emotion, or sentiment to provide newsfeed content and recommend pages, but not for recommending friends or advertisements. The computer system 100, the user communication devices 192, 194, . . . etc., and the storage device 170 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the computer system 100, the user communication devices 192, 194, . . . etc., and the storage device 170 may be restricted in its access, storage, or use of the objects or information. The computer system 100, the user communication devices 192, 194, . . . etc., and the storage device 170 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the computer system 100, the user communication devices 192, 194, . . . etc., and the storage device 170 may temporarily store the message in a content data store until the second user has viewed or downloaded the message, at which point the computer system 100, the user communication devices 192, 194, . . . etc., and the storage device 170 may delete the message from the data store. As another example and not by way of limitation, continuing with the prior example, the message may be stored fora specified period of time (e.g., 2 weeks), after which point may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the computer system 100, the user communication devices 192, 194, . . . etc., and the storage device 170 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the computer system 100, the user communication devices 192, 194, . . . etc., and the storage device 170. The user's privacy settings may specify that such information may be used only for particular processes, such as authentication, and further specify that such information may not be shared with any external system or used for other processes or applications associated with the computer system 100, the user communication devices 192, 194, . . . etc., and the storage device 170. As another example and not by way of limitation, the computer system 100, the user communication devices 192, 194, . . . etc., and the storage device 170 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the computer system 100, the user communication devices 192, 194, . . . etc., and the storage device 170. As another example and not by way of limitation, the computer system 100, the user communication devices 192, 194, . . . etc., and the storage device 170 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the computer system 100, the user communication devices 192, 194, . . . etc., and the storage device 170.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The computer system 100, the user communication devices 192, 194, . . . etc., and the storage device 170 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the computer system 100, the user communication devices 192, 194, . . . etc., and the storage device 170 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the computer system 100, the user communication devices 192, 194, . . . etc., and the storage device 170 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the computer system 100, the user communication devices 192, 194, . . . etc., and the storage device 170 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the computer system 100, the user communication devices 192, 194, . . . etc., and the storage device 170 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the computer system 100, the user communication devices 192, 194, . . . etc., and the storage device 170 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the computer system 100, the user communication devices 192, 194, . . . etc., and the storage device 170 may send a reminder to the user to confirm his or her privacy settings every six months or after every ten photo posts. In particular examples, privacy settings may also allow users to control access to the objects or information on a per-request basis. As an example and not by way of limitation, the computer system 100, the user communication devices 192, 194, . . . etc., and the storage device 170 may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system for providing content, comprising:
a processor; and
a memory storing instructions, which is executable by the processor.

2. The system of claim 1, wherein the instructions, when executed by the processor, cause the processor to:
receive a user request from a user for a personalized route between an origin and a destination;
to receive recommendations based on the user's preferences from one or more recommender systems;
rank the recommendations using at least context data associated with the user request;
select geographical locations associated with at least a top predetermined number of recommendations, wherein the geographical locations lie between the origin and the destination; and
build a personalized route that passes through at least a subset of the geographical locations.

3. The system of claim 1, wherein the instructions, when executed by the processor, cause the processor to:
enable a display of the personalized route on a user communication device that transmitted the user request.

4. The system of claim 3, wherein the instructions, when executed by the processor, cause the processor to:
identify the user based on the user request.

5. The system of claim 1, wherein the instructions, when executed by the processor, cause the processor to:
retrieve the context data associated with the user request from one or more of a plurality of data sources.

6. The system of claim 5, wherein the instructions, when executed by the processor, cause the processor to:
receive as one of the recommendations, a recommendation to provide a scenic route;
retrieve satellite data between the origin and the destination; and
provide the satellite data to a deep learning (DL) model that identifies greenery, wherein the DL model is trained on image classification to identify the greenery.

7. The system of claim 6, wherein the instructions, when executed by the processor, cause the processor to:
build the personalized route passing through areas including the greenery.

8. The system of claim 1, wherein the instructions, when executed by the processor, cause the processor to:
receive a user request for an optimized route between an origin and a destination;
retrieve an initial route between the origin and the destination from a mapping database;
optimize the initial route by reducing a number of turns; and
provide routing instructions based on the optimized route.

9. The system of claim 8, wherein the initial route is generated for a pedestrian route.

10. The system of claim 8, wherein the instructions when executed by the processor further cause the processor to apply an AI-based technique using a Douglas-Peucker process to the initial route using a configurable tolerance threshold.

11. The system of claim 1, wherein the instructions, when executed by the processor, cause the processor to:
activate a wireless network;
detect a transaction device within proximity; and
transmit a first narrow-band transmission signal as a pairing signal to the transaction device.

12. The system of claim 11, wherein the instructions, when executed by the processor, further cause the processor to transmit a second narrow-band transmission signal including transaction data to the transaction device.

13. The system of claim 11, wherein the first narrow-band transmission signal and the second narrow-band transmission signal may be an infrared (IR) signal.

14. The system of claim 11, wherein the transaction data may be encrypted and serialized.

15. The system of claim 11, wherein the pairing signal may be encrypted.

16. A method for providing a personalized route recommendation.

17. The method of claim 16, wherein the method comprises:
receiving a user request for a personalized route between an origin and a destination;
receiving recommendations based on the user's preferences from one or more recommender systems;
ranking the recommendations using at least context data associated with the user request;
selecting geographical locations associated with at least a top predetermined number of recommendations, wherein the geographical locations lie between the origin and the destination; and
building a personalized route that passes through at least a subset of the geographical locations.

18. A non-transitory computer-readable storage medium having an executable stored thereon, which when executed instructs a processor to perform the method of claim 17.

19. The method of claim 16, wherein the method comprises:
activating a wireless network;
detecting a transaction device within proximity;
transmitting a first narrow-band transmission signal as a pairing signal to the transaction device; and
transmitting a second narrow-band transmission signal including transaction data to the transaction device.

20. A non-transitory computer-readable storage medium having an executable stored thereon, which when executed instructs a processor to perform the method of claim 17.
